(19) United States
(12) Patent Application Publication
(10) Pub. No.: US 2016/0063375 A1
(43) Pub. Date: Mar. 3, 2016

(54) DETERMINATION OF SUBSTANCES IN AN ASSEMBLY

(71) Applicant: International Business Machines Corporation, Armonk, NY (US)

(72) Inventors: Thomas C. Gilgert, Poughkeepsie, NY (US); Sophia S. Lau, Woodinville, WA (US); Kenneth S. Lyjak, Fuquay Varina, NC (US); Richard G. McGee, Durham, NC (US); Fabio D. White, Monroe, NY (US)

(21) Appl. No.: 14/472,583

(22) Filed: Aug. 29, 2014

(51) Int. Cl. G06N 5/02

(52) U.S. Cl. CPC G06N 5/022

(57) ABSTRACT

A processor identifies a component included in an assembly. The processor retrieves historical records that indicate which substances are included in the component. The processor determines a probability that the component includes the substances based on at least one historical record. The processor generates a list of substances included in the assembly based on the substances being statistically likely to be present in the component of the assembly.

### BACKGROUND OF THE INVENTION

The present invention relates generally to the field of product environmental compliance, and more particularly to analysis of substances of a component.

Entities may place product orders on-line followed by shipment of the product directly to the requesting consuming entity. At the same time, it is known that products offered for sale may be subject to different geographic compliance rules and regulations. There are forms of rules and regulations associated with product sales, including but not limited to, import and export, regulation of materials, etc. Tracking relevant rules and regulations for one product is difficult; tracking relevant rules and regulations for a plurality of products is even more challenging.

There are a wide variety of environmental laws (statutes, regulations, etc.) governing the manufacture, importation, distribution and sale of various substances in different countries and regions of the world. In general, these laws are generally known as hazardous substances laws. Hazardous substances laws are designed to protect human health and the surrounding environment from the deleterious effects of hazardous substances. As environmental concerns have grown, so have the restrictions placed on products that contain hazardous substances, such as toxic chemicals and heavy metals.

Hazardous substances laws in general are considered to have two main components: registration requirements and special requirements. Registration requirements have followed two lines of evolution resulting in product-based laws and inventory laws. Both types of registration have been interpreted to have registration (inventory) exemptions for incidental impurities, byproducts, and non-regulated substances. Product-based laws require registration of the exact substance composition of each product (i.e., finished good) with the proper government authorities of the end-use country or region.

### SUMMARY

Embodiments of the present invention provide a method, system, and program product for determining substances within an assembly. A processor identifies a component included in an assembly. The processor retrieves a list of one or more historical records that indicate a substance is included in the component. The processor determines a probability that the component includes the substance based, at least in part, on at least one historical record included in the list of historical records. The processor generates a first list of substances for the assembly that are statistically likely to be present in the assembly based on, at least in part, a probability that indicates the component does include the substance.

### BRIEF DESCRIPTION OF THE SEVERAL VIEWS OF THE DRAWINGS

FIG. 1 is a functional block diagram illustrating a product analysis environment, in accordance with an exemplary embodiment of the present invention.

FIG. 2 illustrates operational processes of an assembly analysis program, executing on a computing device within the environment of FIG. 1, in accordance with an exemplary embodiment of the present invention.

FIG. 3 depicts a block diagram of components of the computing device executing an assembly analysis program, in accordance with an exemplary embodiment of the present invention.

### DETAILED DESCRIPTION

Embodiments of the present invention recognize that substances included in an assembly do not always match the substances indicated by an environmental product declaration for that assembly. Embodiments of the present invention recognize that a quantity of a substance included in an assembly does not always match the quantity of that substance as indicated by an environmental product declaration for that assembly. Embodiments of the present invention provide a reduction in one or both of the amount of testing and type of testing needed to evaluate an assembly for environmental compliance. Embodiments of the present invention recognize identifying historical records of a component included in an assembly that are statistically likely to represent one or both of the type of substances included in a component and the quantity of those substances in the component. Embodiments of the present invention recognize combining historical records of components included in an assembly to generate a statistically likely combination of substances that are included in the assembly. Embodiments of the present invention recognize combining historical records of components included in an assembly to generate a statistically likely quantity of a substance that is included in the assembly.

The present invention will now be described in detail with reference to the Figures.

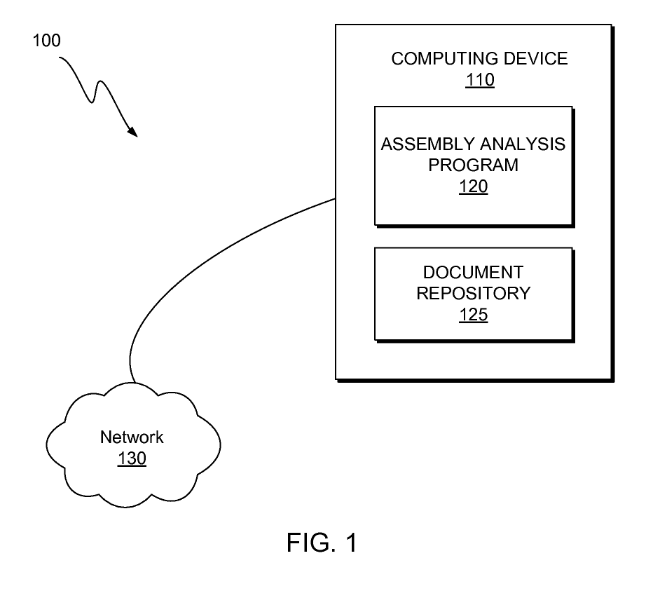

FIG. 1 is a functional block diagram illustrating product analysis environment, generally designated 100, in accordance with one embodiment of the present invention. Product analysis environment 100 includes computing device 110 connected over network 130. Computing device 110 includes substance determining program assembly analysis program 120 and data repository 125.

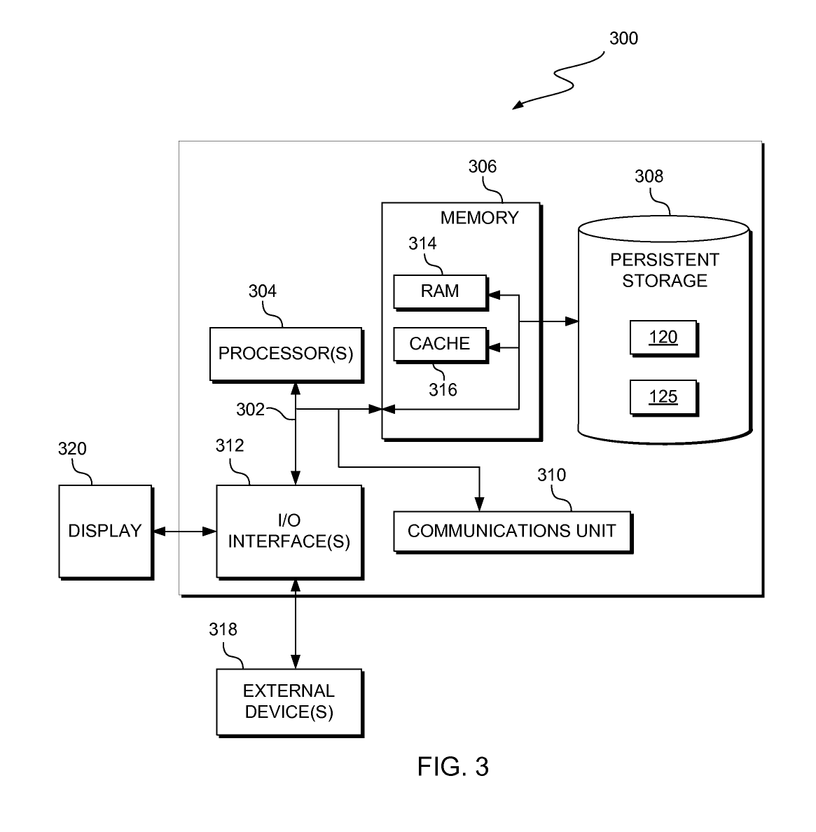

In various embodiments of the present invention, computing device 110 is a computing device that is one of a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 is any computing device or a combination of devices with access to assembly analysis program 120 and data repository 125 and is capable of executing assembly analysis program 120. In an embodiment, computing device 110 include internal and external hardware components, as depicted and described in further detail with respect to FIG. 3.

In this exemplary embodiment, assembly analysis program 120 and data repository 125 are stored on computing device 110. However, in other embodiments, one or both of assembly analysis program 120 and data repository 125 are stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110 and assembly analysis program 120 and data repository 125, in accordance with a desired embodiment of the present invention.

In an embodiment, assembly analysis program 120 identifies the substances included in an assembly by identifying the composition of components included in that assembly. For example, an assembly is a computer. The assembly includes components such as chassis, printed circuit boards, plastic covers, electrical cables, and a display, etc. Assembly analysis program 120 searches historical data and identifies records that include the historical composition of the components included in the assembly. As used herein, the composition of a component refers the substances that are included in the component, such as chemicals and specific elements, such as, for example, various heavy metals and radioactive isotopes.

In one embodiment, assembly analysis program 120 increases the accuracy of assessment of substances included in an assembly by reducing errors, such as, for example, errors from differences in skill level between assessors, knowledge of components, and the overlooking of a component in an assembly.

In an embodiment, assembly analysis program 120 determines a statistical likelihood that the historical composition of a component is representative of the component included in the assembly. As such, assembly analysis program 120 determines a likely composition for certain components and further identifies components for which there is insufficient or missing historical composition records. Assembly analysis program 120 generates a composition for at least part of the assembly based, in part, on the likely composition for components included in the assembly. Assembly analysis program 120 also generates a suggested battery of tests to be performed on various components for which there is insufficient or missing historical composition records. In some embodiments, in response to the identification of a hazardous substance that is known to be included in a component, assembly analysis program 120 generates a suggested battery of tests to be performed on various components or on the assembly as a whole.

In one embodiment, assembly analysis program 120 combines the likely composition for components included in the assembly with the compositions for components as determined via testing, to generate a composition for the entire assembly. In some embodiments, assembly analysis program 120 also determines a probability that the generated composition for the entire assembly is representative of the actual composition of the assembly. In some embodiments, such a probability includes a risk assessment that indicates how likely the assembly is to contain hazardous substances that have not been identified in the generated composition for the entire assembly.

In one embodiment, assembly analysis program 120 compares the substances that assembly analysis program 120 predicts to be included in as assembly to substances that are indicated to be included in the assembly according to a standardized product declaration for the assembly. The standardized product declaration for the assembly, produced by assembly analysis program 120, includes probability and predictive values that are used for, but not limited to, product risk assessment and regulatory “due diligence testing.” For example, in one embodiment, assembly analysis program 120 generates an environmental product declaration environmental product declaration (EPD) as the standardized product declaration for the assembly. An EPD is a standardized way of quantifying the environmental impact of a product or system. As used herein, such standardized product declarations at least designate the substances included in the assembly as a whole. In other embodiments, such standardized product declarations also include information on the environmental impact of raw material acquisition, energy use and efficiency, content of materials and chemical substances, emissions to air, soil and water and waste generation. Product and company information is also included. In one embodiment, assembly analysis program 120 compares quantity of a substance that assembly analysis program 120 predicts to be included in as assembly to the quantity of that substance that is indicated to be included in the assembly according to an environmental product declaration for the assembly. In one embodiment, based on at least one of the above comparisons, in response to a discrepancy between one or both of the type of substance included in the assembly and a quantity of a substance included in the assembly, assembly analysis program recommends one or more tests to be performed on at least one component of the assembly that is required to satisfy regulatory “due diligence”, i.e., to satisfy legal regulations that specify one or more activities be conducted and disclosures made regarding the substances included in as assembly.

In an embodiment, data repository 125 includes a database of records for various components that have been included in previous assemblies. These records include, for example, information such as engineering drawings, part numbers and other identification information, dates of file updates for respective components, lists of components that are used interchangeably in industry, and the tested and verified composition of respective components, if available. In some embodiments, the records further include statistical likelihood that a composition has changed for a given type of component. In some embodiments, assembly analysis program 120 accesses network 130, and updates the records included in data repository 125 on a regular basis, a semi-regular basis, or in response to a request from a user.

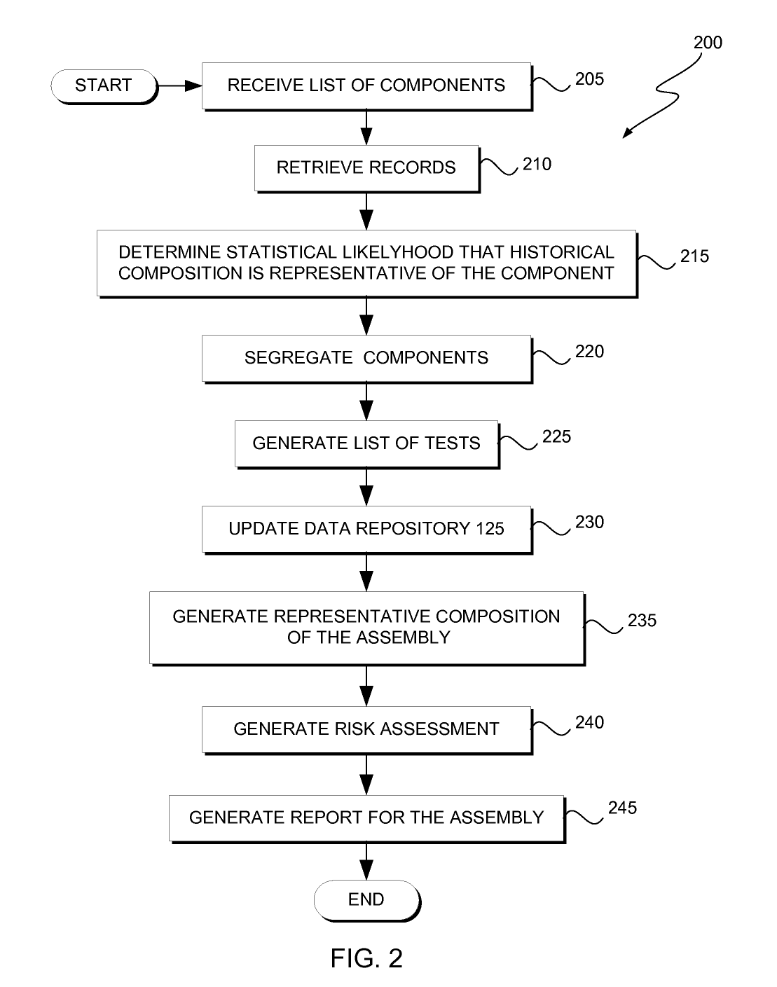

FIG. 2 illustrates operational processes of assembly analysis program 120, executing on computing device 110 within the environment of FIG. 1, in accordance with an exemplary embodiment of the present invention.

In process 205, assembly analysis program 120 receives list of components included in an assembly. For example, assembly analysis program 120 receives a request for an analysis of assembly T39. Assembly analysis program 120 accesses data repository 125 and retrieves a list of components included in assembly T39. In another example, a user enters the name of an assembly and a list of components included in that assembly. In such a case, assembly analysis program 120 creates a file for assembly T39, which is included as part of data repository 125. The file indicates the date the file was created as well as the name of the assembly (T39) and a list of components included in assembly T39.

In process 210, assembly analysis program 120 retrieves records of historical composition of the components included in the assembly from data repository 125. For example, an assembly (K52) includes components 1A-1D, 3C1-3C14 and T12. As such, assembly analysis program 120 searches data repository 125 for records of historical composition of components 1A-1D, 3C1-3C14 and T12. Assembly analysis program 120 retrieves the historical composition records corresponding to components 1A-1D, 3C1-3C14 and T12.

In some embodiments, assembly analysis program 120 verifies the identity of components included in an assembly based on historical inclusion of those components in an assembly of the type being assessed. For example, assembly “X” is being analyzed. Assembly analysis program 120 accesses data repository 125 and matches assembly X to an assembly type “Y”, which is included in a list of assembly types included in data repository 125. Assembly analysis program 120 determines that, historically, all assembly type Y have included component “Z”. As such, assembly analysis program 120 verifies that component Z has been included in the list of components of assembly X. If component Z has not been included in that list of components, then assembly analysis program 120 generates a warning indicating that components (specifically, component Z) are missing from the list of components of assembly X.

In certain embodiments, assembly analysis program 120 cross references a list of alternative components for component Z, which is included in the list of assembly types included in data repository 125, e.g., the alternative component and component Z are both of component type A1. In such embodiments, assembly analysis program 120 verifies whether an alternative component for component Z has been included in the list of components of assembly X. If such an alternative component has been included in the list of components for assembly X, then assembly analysis program 120 does not generate the warning indicating that component Z is missing from the list of components of assembly X. Assembly analysis program 120 retrieves records of historical composition, of the alternative components included in the assembly, from data repository 125.

In process 215, assembly analysis program 120 determines a statistical likelihood that the historical composition of a component is representative of the component included in the assembly. In some cases such a statistical likelihood is based on one or more of: a number of previous changes in composition, how often those changes occurred and on identification of advancements in the materials used for that type of component, and a known release of a new line of products from a given manufacturer.

In this embodiment, assembly analysis program 120 determines whether certain historical compositions of a certain component are to be disregarded, i.e., removed from consideration when determining the most likely composition of that component. In some cases, historical compositions are removed from consideration based on the age of the record. In certain scenarios, the age of a product line that includes a particular component indicates the level of risk that a change in component composition has occurred and is not reflected in the historical records for that component. For example, if the product line has not changed in for a certain period of time, then this indicates a high probability that the composition of the component is the same as, or substantially similar to, the historical composition for that component. In this example, product lines from manufacturer “ABC2” have an average production span of ten years. There are historical composition records for component Q in data repository 125 that span the previous three years. Component Q has been in production for five years, therefore there is a low probability that the composition of component Q has changed in the last three years, which indicates that the historical composition of component Q is likely representative of the composition of component Q included in the assembly.

In other scenarios, the age of the product line indicates a high probability that the composition of the component is not verified by sufficient numbers of test results. For example, a new line of products, including component P, is released from manufacturer ABC2. Given the recent release of the new product line, the number of assemblies including component P are low. As such, the number of tests that determine the composition of component P are low, which means that there are a proportionately low number of records included in data repository 125 that include a composition for component P.

In addition, in some scenarios, there is an increased likelihood of change in composition for a new product line during an initial production period. For example, an initial production run for component P using composition “A” results in numerous complaints from the purchasers of that component, which indicate that there is a structural flaw that results from composition A. In response, the manufacturer changes the composition used to produce component P to composition “B” for a second manufacturing run. As such, any records for the initial run of component P would represent the composition of component P as being composition A. However, if an assembly is utilizing component P from the second run, then the records included in data repository 125 are no longer representative of the composition of component P. In certain embodiments, assembly analysis program 120 is configured to identify trends in the changes of component composition based on one or more identified changes in the records of data repository 125 and information retrieved by assembly analysis program 120 via network 130, such as press releases and manufacturing records. In such embodiments, assembly analysis program 120 uses such trends to predict likely compositions for components, which are then saved as part of the records of data repository 125. For example, a trend shows an increase in quantity of substance “QWR” in component “T5” of three percent every five years. The records included in data repository are three years old. As such, assembly analysis program 120 predicts the quantity of substance “QWR” in a component T5 that was produced one month ago based, at least in part on the trend and the most recent records for component T5 that are included in data repository 125.

In this embodiment, assembly analysis program 120 determines whether a historical composition of a certain component is to be disregarded when determining the composition of that particular component, based, in part, on the time duration of a product line being manufactured. In some scenarios a change in composition is indicated by a change in the technology utilized by the component itself or in a change in the technology used to manufacture that component. Assembly analysis program 120 also searches other data sources, such as the Internet, via network 130, for indications that a product line has, for example, changed composition. Such indications include, for example, press releases indicating a new product line or component, and records from the manufacturer indicating a change in composition of a component. In some scenarios, such indications are included as part of data repository 125. Based on such indications, assembly analysis program 120 determines whether to disregard one or more records, included in data repository 125, for a particular component of the assembly.

The disregarding of certain historical compositions of a given component typically increases the statistical likelihood that the remaining historical compositions of a component are representative of the component included in the assembly. In some cases, the most likely composition for a component is an unknown composition. Such scenarios result when the assembly includes components for which there is insufficient historical composition records, for example, when the records were disregarded. Such scenarios also result when there are no historical composition records for a given component.

In process 220, assembly analysis program 120 segregates the components of the assembly into two groups. The first group components includes components for which there is a historical composition with a high probability of being representative of the component included in the assembly. Assembly analysis program 120 assigns such historical compositions as the compositions of their respective components included in the assembly. In some scenarios such an assignment of composition reduces the total amount of testing that is required to determine a representative composition of an assembly. The second groups of components includes components for which there is no historical composition with a high probability of being representative of the component included in the assembly. In general, the second group includes components which have indications that a change in composition was made along with components that have insufficient historical composition records with which to derive a historical composition with a high probability of being representative of the component included in the assembly.

In process 225, assembly analysis program 120 generates a suggested list of tests to be performed on at least the second group of components included in the assembly. In some scenarios, if assembly analysis program 120 identifies a hazardous substance that is known to be included in a component of the first group, then assembly analysis program 120 also generates a suggested list of tests to be performed on various components of the first group, or on the assembly as a whole. In some embodiments, the generation of a suggested list of tests to be performed on one or more components of an assembly is based on a statistical likelihood that various components include the hazardous substance. For example, the historical composition records of component “A55” indicate that component A55 is currently manufactured using composition “C”, which does not include heavy metals. However, the historical composition records of component A55 also indicate that component A55 was previously manufactured using composition B, which did include heavy metals. As such, assembly analysis program 120 generates a suggested list of tests for component A55 that includes tests to determine the heavy metal content of component A55.

In some embodiments, assembly analysis program 120 takes into account the time duration between changes in composition for a given component when generating a suggested list of tests. For example, in continuation with the above example, the historical composition records of component A55 also indicate that component A55 was previously manufactured using composition A, which included several carcinogenic reagents during the manufacturing process. When the manufacturer changed to composition B the manufacturing process was modified to remove the use of those carcinogenic reagents and their use was not reinstituted when the manufacturer changed to composition C. The time difference between the terminal use of composition A and the initial use of composition C is twelve years. As such, while the historical composition records for the component do indicate the previous use of carcinogenic reagents during the manufacturing of the component, assembly analysis program 120 determines that there is a low probability that testing for carcinogenic reagents is needed. As such, assembly analysis program 120 does not generate the suggested list of tests to be performed to include tests for carcinogenic reagents based on the historical composition records for that component.

In this embodiment, in process 230, assembly analysis program 120 updates data repository 125 with results generated by completion of the suggested list(s) of tests. The results of the suggested list(s) of tests indicate a composition for each of the components included in the second group of components as well as any components included in the first group for which testing was suggested. In the case of assembly analysis program 120 having suggested a list of testing be performed on a component that is included in the first group, assembly analysis program 120 updates the assigned composition that was assigned to the respective component, during process 220, to reflect the results of the testing.

In this embodiment, in process 235, assembly analysis program 120 generates a representative composition for the entire assembly by combining the respective compositions for components included in the first group and second group of components of the assembly. The representative composition reflects the results of any testing of the components that was performed as well as the assigned compositions generated during process 220.

In this embodiment, in process 240, assembly analysis program 120 generates a risk assessment for the assembly that reflects a statistical assessment of the accuracy and precision of the combined composition representing the actual composition of the assembly. In one embodiment, assembly analysis program 120 generates a risk assessment that is configured to represent one or both of hazardous and non-hazardous substances.

In this embodiment, the accuracy associated with the combined composition reflects the various substances that are statistically likely to be present in the assembly. In other words, the accuracy represents the odds that one or more substance are either incorrectly included or excluded from the combined composition of the assembly. In this embodiment, assembly analysis program 120 assesses not only the identity of various substances but also the quantity of those substances, i.e., the precision of respective quantities of substances included in the composition. In this embodiment, the precision associated with the combined composition reflects a margin of error in the quantity of a given substance in a combined composition.

In general, contradictions between the assigned composition of a component and a composition determined via testing results in a lowering of one or both of the accuracy and precision of the combined composition representing the actual composition of the assembly. To simplify the following discussion, a contradiction between the substances of an assigned composition of a component and the substances included in that component as determined via testing, or a contradiction between a quantity of a substance in the assigned composition and a quantity of that substance as determined via testing, are both herein referred to as a “contradiction”. In this embodiment, if either the accuracy or precision of the combined composition is below a threshold, assembly analysis program 120 generates a list of tests to be performed to rectify the contradiction.

In one embodiment, assembly analysis program 120 responds to a contradiction that is above a threshold, which is configured for such contradictions, by generating a list of tests to be performed to rectify the contradiction even if one or both of the accuracy or precision of the combined composition is above a respective threshold. In one embodiment, assembly analysis program 120 responds to a contradiction that is above a threshold by generating a message that indicates the contradiction. In one embodiment, one or both of a statistical assessment of the accuracy or precision of a composition of respective components are included as part of the records included in data repository 125. In certain embodiments, assembly analysis 120 combines the accuracy or precision of a composition of respective components to generate one or both of an accuracy or precision of the combined composition of the assembly.

In some embodiments, thresholds for one or both of accuracy and precision are used by assembly analysis 120 to determine whether further testing is needed for one or more components that are included in the assembly. For example, a risk assessment indicates that there is 99.98% accuracy in the substances that are present in an assembly, which is well above the accuracy threshold of 99%. In other words, 99.98% accuracy in the substances that are present in an assembly indicates that there is a low probability that the assembly includes a substance that is not identified by the combined composition. However, there is a 78% to 99.97% range of precision for the respective quantities of those substances. As such, assembly analysis program 120 identifies the substances that are below a precision threshold of 98% and generates a list of tests to be performed to better quantify the amounts of those substances in the combined composition. The tests are carried out and the combined composition updated accordingly. The resulting range of precision for the combined composition is 99.5% to 99.97%, which is well above the threshold for precision.

Similarly, if the accuracy is below the threshold for accuracy, then analysis program 120 identifies the components that are statistically probable to include unidentified substances and generates a list of tests to be performed to identify the substances in those components. In one example, such scenario arises when sufficient historical composition records existed to assign a composition to component 123, which includes the heavy metal lead. However, later testing of component 123 for heavy metals resulted in both lead and mercury being identified. As such, the combined composition of the component did not include a substance that was identified during testing. This disparity results in a low accuracy for the combined composition. As such, analysis program 120 generates a list of tests to be performed on that component since the disparity included a substance that was listed as hazardous. In certain embodiments, analysis program 120 responds to the inclusion of one or more toxic, carcinogenic or otherwise hazardous substances in a component by generating a list of tests to be performed on that component. In some scenarios, this results in an increase in one or both of the accuracy and precision of the risk assessment for the component.

In this embodiment, in process 245, assembly analysis program 120 generates a report for the assembly. To generate the report, assembly analysis program 120 determines a degree of confidence that indicates whether the generated composition for the entire assembly is representative of the actual composition of the assembly. Such a degree of confidence is based, at least in part, on the results of risk assessment. The report includes a list of substances included in the assembly as well as quantities for each substance, tests that were run on components, the results of those tests, and any messages that indicate the presence of hazardous substances in the assembly. In general, such a report is configured to meet or exceed one or more requirements for disclosure of hazardous substances in an assembly.

FIG. 3 depicts a block diagram, 300, of components of computing device 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Assembly analysis program 120 and data repository 125 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. In one embodiment, one or both of assembly analysis program 120 and data repository 125 are, in whole or in part, downloaded to persistent storage 308 through communications unit 310.

I/O interface(s) 312 allows for input and output of data with other devices that may be connected to computing device 110. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., assembly analysis program 120 and data repository 125, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method for determining substances within an assembly, the method comprising:
identifying, by a processor, a component included in an assembly;
retrieving, by the processor, a list of one or more historical records that indicate a substance is included in the component;
determining, by the processor, a probability that the component includes the substance based, at least in part, on at least one historical record included in the list of historical records; and
generating, by the processor, a first list of substances for the assembly that are statistically likely to be present in the assembly based on, at least in part, a probability that indicates the component does include the substance.

2. The method of claim 1, the method further comprising:
comparing, by the processor, the first list of substances for the assembly with a second list of substances for the assembly that are included in a environmental product declaration;
identifying, by the processor, a difference in a quantity of a substance that is included in the first list of substances and the second list of substances; and
identifying, by the processor, a test to be performed to determine an actual quantity of the substance present in the assembly.

3. The method of claim 1, the method further comprising:
comparing, by the processor, the first list of substances for the assembly with a second list of substances for the assembly that are included in a environmental product declaration;
identifying, by the processor, a substance that is included in only one of the first list of substances or the second list of substances; and
identifying, by the processor, a test to be performed to verify whether the substance is present in the assembly.

4. The method of claim 1, the method further comprising:
removing, by the processor, a historical record from the list of one or more historical records based, at least in part, on a statistically probably that the historical record includes a composition of substances for the component that do not represent the actual composition of substances for the component included in the assembly.

5. The method of claim 1, the method further comprising:
determining, by the processor, whether there exists a number of historical records from which to determine a statistically probably composition of substances for the component included in the assembly.

6. The method of claim 5, the method further comprising:
responsive to a determination that there does not exist the number of historical records, identifying, by the processor, a test to be performed to identify one or more substances present in the component.

7. The method of claim 1, the method further comprising:
determining, by the processor, a probability that the first list of substances for the assembly represent the actual substances present in the assembly.

8. A computer program product for determining substances within an assembly, the computer program product comprising:
a computer-readable storage media and program instructions stored on the computer-readable storage media, the program instructions comprising:
program instructions to identify a component included in an assembly;
program instructions to retrieve a list of one or more historical records that indicate a substance is included in the component;
program instructions to determine a probability that the component includes the substance based, at least in part, on at least one historical record included in the list of historical records; and
program instructions to generate a first list of substances for the assembly that are statistically likely to be present in the assembly based on, at least in part, a probability that indicates the component does include the substance.

9. The computer program product of claim 8, the program instructions further comprising:
program instructions to compare the first list of substances for the assembly with a second list of substances for the assembly that are included in a environmental product declaration;
program instructions to identify a difference in a quantity of a substance that is included in the first list of substances and the second list of substances; and
program instructions to identify a test to be performed to determine an actual quantity of the substance present in the assembly.

10. The computer program product of claim 8, the program instructions further comprising:
program instructions to compare the first list of substances for the assembly with a second list of substances for the assembly that are included in a environmental product declaration;
program instructions to identify a substance that is included in only one of the first list of substances or the second list of substances; and
program instructions to identify a test to be performed to verify whether the substance is present in the assembly.

11. The computer program product of claim 8, the program instructions further comprising:
program instructions to remove a historical record from the list of one or more historical records based, at least in part, on a statistically probably that the historical record includes a composition of substances for the component that do not represent the actual composition of substances for the component included in the assembly.

12. The computer program product of claim 8, the program instructions further comprising:
program instructions to determine whether there exists a number of historical records from which to determine a statistically probably composition of substances for the component included in the assembly.

13. The computer program product of claim 12, the program instructions further comprising:
program instructions to respond to a determination that there does not exist the number of historical records, by identifying a test to be performed to identify one or more substances present in the component.

14. The computer program product of claim 8, the program instructions further comprising:
program instructions to determine a probability that the first list of substances for the assembly represent the actual substances present in the assembly.

15. A computer system for determining substances within an assembly, the computer system comprising:
a processor;
a computer readable storage medium;
program instructions stored on the computer readable storage medium for execution by at least one of the processor, the program instructions comprising:
program instructions to identify a component included in an assembly;
program instructions to retrieve a list of one or more historical records that indicate a substance is included in the component;
program instructions to determine a probability that the component includes the substance based, at least in part, on at least one historical record included in the list of historical records; and
program instructions to generate a first list of substances for the assembly that are statistically likely to be present in the assembly based on, at least in part, a probability that indicates the component does include the substance.

16. The computer system of claim 15, the program instructions further comprising:
program instructions to compare the first list of substances for the assembly with a second list of substances for the assembly that are included in a environmental product declaration;
program instructions to identify a difference in a quantity of a substance that is included in the first list of substances and the second list of substances; and
program instructions to identify a test to be performed to determine an actual quantity of the substance present in the assembly.

17. The computer system of claim 15, the program instructions further comprising:
program instructions to compare the first list of substances for the assembly with a second list of substances for the assembly that are included in a environmental product declaration;
program instructions to identify a substance that is included in only one of the first list of substances or the second list of substances; and
program instructions to identify a test to be performed to verify whether the substance is present in the assembly.

18. The computer system of claim 15, the program instructions further comprising:
program instructions to remove a historical record from the list of one or more historical records based, at least in part, on a statistically probably that the historical record includes a composition of substances for the component that do not represent the actual composition of substances for the component included in the assembly.

19. The computer system of claim 15, the program instructions further comprising:
program instructions to determine whether there exists a number of historical records from which to determine a statistically probably composition of substances for the component included in the assembly.

20. The computer system of claim 15, the program instructions further comprising:
program instructions to determine a probability that the first list of substances for the assembly represent the actual substances present in the assembly.
